(19) United States
(12) Patent Application Publication
(10) Pub. No.: US 2020/0094277 A1
(43) Pub. Date: Mar. 26, 2020

(54) HAND-DEPRESSING VACUUM PUMPING DEVICE

(71) Applicant: LIH YANN INDUSTRIAL CO., LTD., Taichung (TW)

(72) Inventor: Po Lin LIAO, Taichung (TW)

(73) Assignee: LIH YANN INDUSTRIAL CO., LTD.

(21) Appl. No.: 16/136,395

(22) Filed: Sep. 20, 2018

(51) Int. Cl. B05B 9/08

(52) U.S. Cl. CPC B05B 9/0816

(57) ABSTRACT

A hand-depressing vacuum pumping device includes a liquid container having a top connected to a guide cover, which has a first passage in communication with an interior receiving space of the liquid container, a float-based safety switch, a check valve, and an exposed tube connected to a top of a pump cylinder. The pump cylinder includes a one-way piston arranged therein and the one-way piston is connected to a piston rod and a pressing stem. The pump cylinder has a bottom end connected to a second passage of the guide cover. Depressing the pressing stem downward causes the one-way piston to expel air out and pulling the pressing stem upward causes air to flow from the interior of the liquid container through the one-way piston to the bottom of the pump cylinder so as to evacuate the receiving space of the container to generate vacuum that induces a suction force.

### BACKGROUND OF THE INVENTION

### 1. Field of the Invention

The present invention relates to the field of hand-operating pumping devices, and more particularly to a hand-depressing vacuum pumping device, which is easy to operate with less effort and has a pump cylinder that is exposed and detachable and can be readily detached and re-mounted for easy assembly and replacement.

### 2. The Related Arts

FIG. 1 shows a prior art pump proposed in U.S. Pat. No. 9,222,471, owned by the applicant, which discloses a structure of pump including a cap 11 that is fit to an opening of a pump body 10. The pump body 10 has a circumference that is provided with an external thread 23 at a location close to a top thereof to receive a rotatable fixing ring 12 having an internal thread to screw to for fixing so as to secure the cap 11 from the top side and also to rotate about the circumference for threading engagement to fix the cap 11 and the pump body 10 together. The cap 11 is provided with a projecting ring extending downward from an inside surface thereof. The projecting ring is formed with a thread. A piston cylinder 13 has an end that is provided with a thread for mounting and fixing to the thread of the projecting ring and this completes assembling of the piston cylinder 13. The assembling and removal for maintenance and repair are easy to carry out and thus, the cost could be dropped significantly. No experienced operator is needed for maintenance and repairing. The number of parts is reduced. The size of the cylindrical shape of the pump body 10 is not subjected to any constraint for any size or shape of pump that can be fixed by means of the cap 11 and the rotatable fixing ring. However, in such a known pump, most parts are disposed inside the pump body 10 and thus, any service or maintenance must be carried out by first disassembling the entire pump. This makes maintenance service trouble and tedious.

FIG. 2 shows a known sideway-pulling hand-operating pumping machine that is disclosed in Taiwan Utility Model Application No. 104207471, also owned by the applicant. The known pumping device includes a liquid container 14 that is provided with a liquid suction hole at one side portion of a top thereof for installation of a liquid suction tube therein. A handle, a pressure gauge, and a cap-closable liquid pouring opening are provided on a sidewall of the container. A pumping unit includes a vertical head section with an oblique pumping device 15 integrally and sideways extending therefrom in an inclined manner. The vertical head section is provided, on a lower side thereof with a stop ring and a fastening element to pivotally mount a fixing cover thereto. The fixing cover is formed with an internal thread. The container 14 is provided with an opening having an external thread for threading engagement and coupling with the fixing cover. The fixing cover and the pumping device 15 are arranged in a rotatable relationship so that the pumping device 15 is allowed to make rotation over a full, 360-degree turn for taking the best orientation for force application. A float structure is fixed at the lower side of the fastening element. A float of the float structure points in a direction toward the bottom of the container. Drawing in liquid through vacuum suction to an extent of being almost full would cause the float to move upward and thus shut down further evacuation. Pouring out the liquid would allow the float to move downward for restoring evacuation of air and drawing liquid in. However, most of the components are located inside the machine and disassembling is a trouble and tedious process. In addition, when the pressure rises to a certain level, the operation of pushing and pulling in the sideway direction would become difficult, and would readily cause tiredness of hands and also problems of immobility.

In consideration of the drawbacks of the prior art discussed above, it is a challenge of those involved in this field to provide a novel structure that helps overcome or alleviates the above problems.

In view of this, the present invention aims to provide a technical solution that overcomes the drawbacks of the prior art.

### SUMMARY OF THE INVENTION

The primary objective of the present invention is to provide a hand-depressing vacuum pumping device that comprises a pump unit that is operated through depression or downward pressing, so as to achieve effects of saving effort, occupying a less amount of space, and being easy to operate, and includes components, such as the pump unit, which are exposed outside, are detachable, and are easy to remove for service.

To achieve the above objective, the present invention provides a hand-depressing vacuum pumping device, which comprises a liquid container and a guide cover mounted to a top of the liquid container and formed with a first passage in communication with an interior receiving space of the liquid container. The first passage is provided with a float-based safety switch and a check valve. The first passage is connected to and in communication with an exposed tube, which is connected to and in communication with a top of a pump cylinder. A one-way piston is arranged in the pump cylinder and is connected to a pressing stem. A bottom of the pump cylinder is connected to the guide cover and is in communication with a second passage formed in the guide cover and in communication with the outside. A liquid drawing tube is mounted to one side of the liquid container the receiving space. As such, depressing the pressing stem downward causes the one-way piston to expel air out and pulling the pressing stem upward causes air to flow from the interior of the liquid container through the one-way piston to the bottom of the pump cylinder. Repeating of this operation evacuates the receiving space of the container to generate vacuum that induces a suction force for drawing liquid into the container. The components of this device are simple and the number of components involved is small. The components are exposed to the outside and are detachable so that removal and replacement can be conducted easily. The operation of the device is carried out through depressing so that the operation can be carried out with less effort. The device only occupies a reduced amount of space, and the operation of the device is easy and simple.

### BRIEF DESCRIPTION OF THE DRAWINGS

The present invention can be fully understood from the following detailed description and preferred embodiments with reference to the accompanying drawings, in which:

FIG. 1 is a cross-sectional view showing a known device disclosed in U.S. Pat. No. 9,222,471;

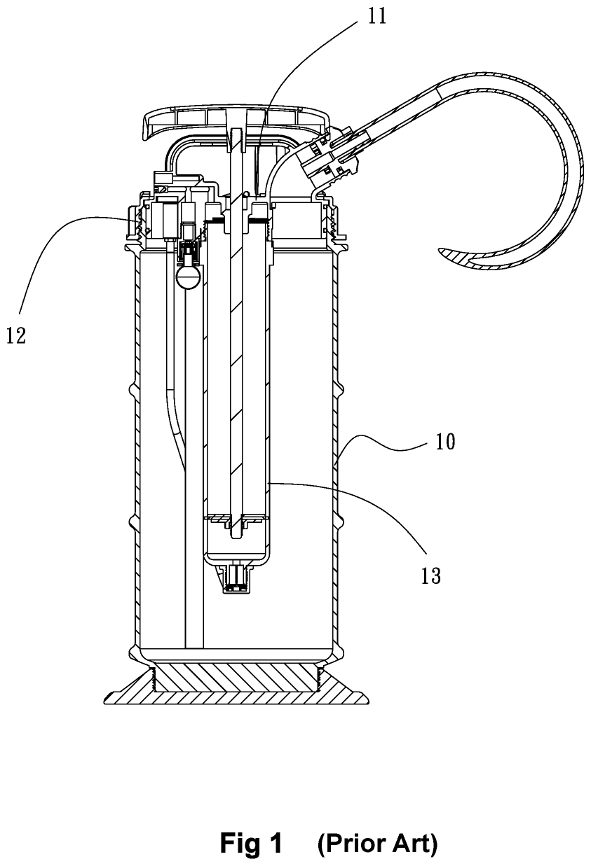

FIG. 2 is a perspective view showing a known device disclosed in Taiwan Utility Model Application No. 104207471;

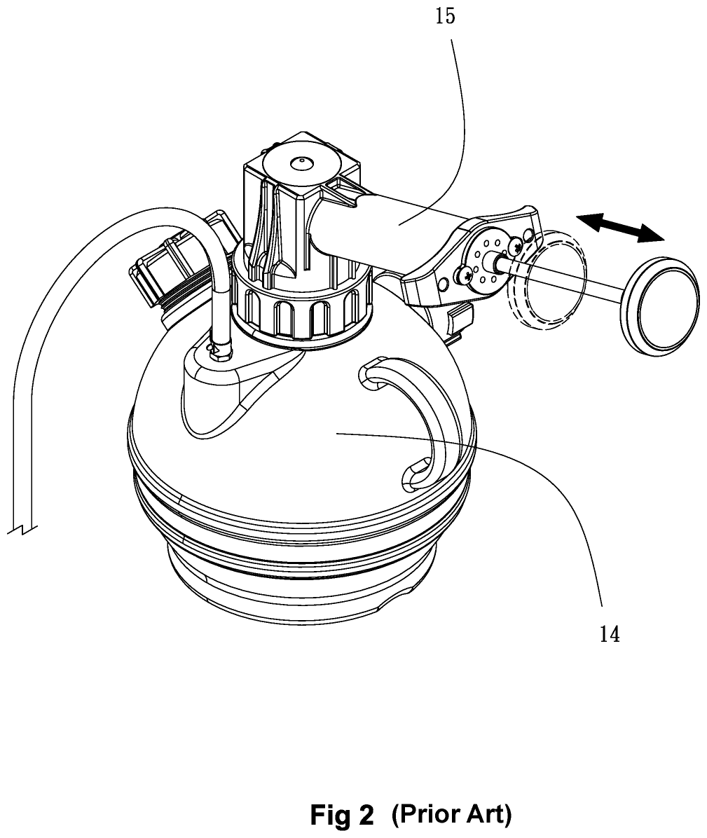

FIG. 3 is a perspective view showing an embodiment of the present invention;

FIG. 4 is a cross-sectional view showing an embodiment of the present invention;

FIG. 5 is an enlarged view of a circled portion A of FIG. 4;

FIG. 6 is an exploded view showing an embodiment of the present invention;

FIG. 7 is a left side elevational view showing an embodiment of the present invention;

FIG. 8 is a front view showing an embodiment of the present invention;

FIG. 9 is a top plan view showing an embodiment of the present invention; and

FIG. 10 is a right side elevational view showing an embodiment of the present invention.

### DETAILED DESCRIPTION OF THE PREFERRED EMBODIMENTS

The present invention provides a hand-depressing vacuum pumping device.

To better expound the purposes, features, and advantages of the present invention, a detailed description will be given below with reference to an embodiment thereof and the drawings.

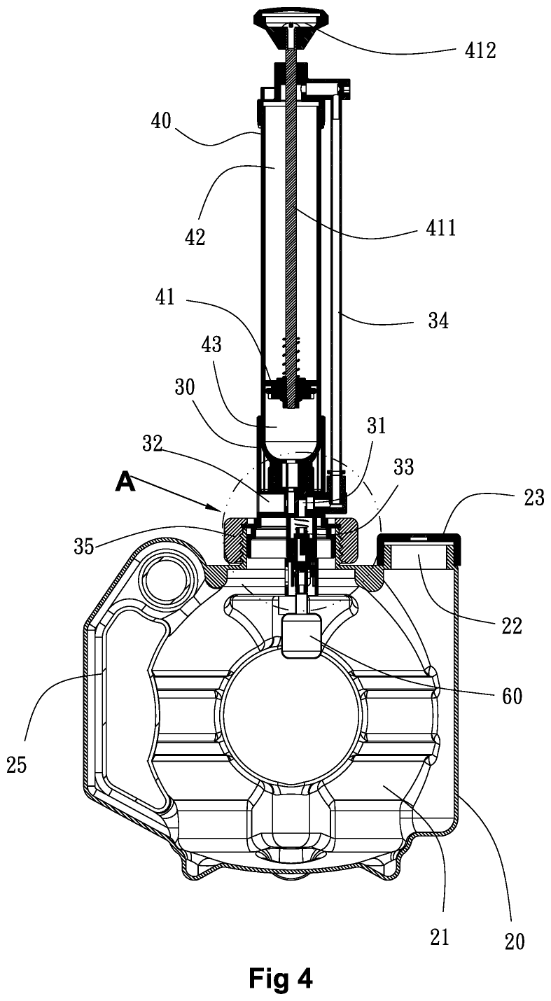

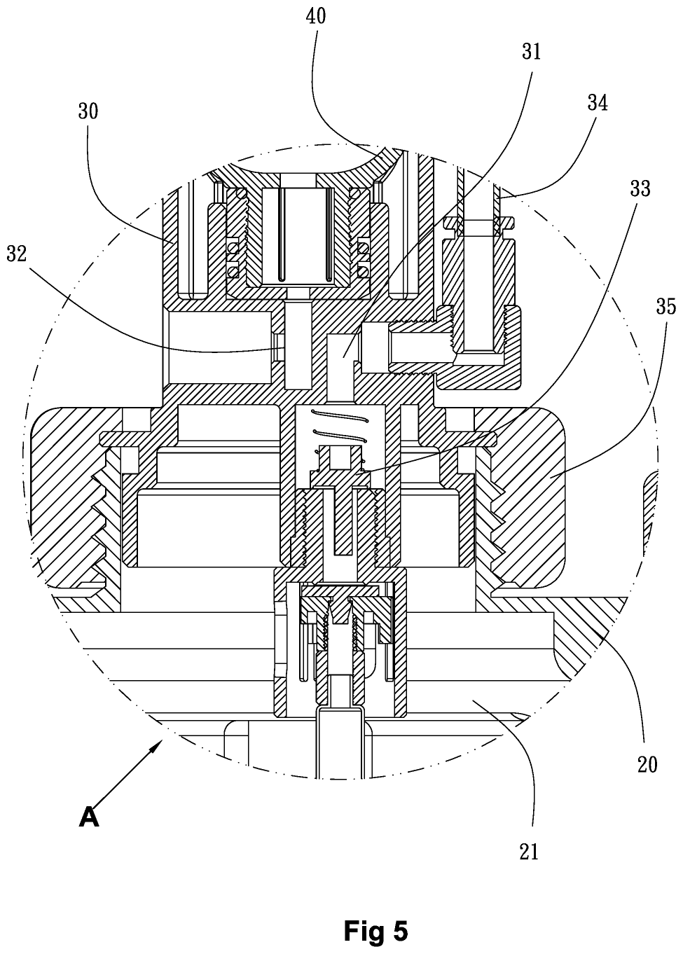

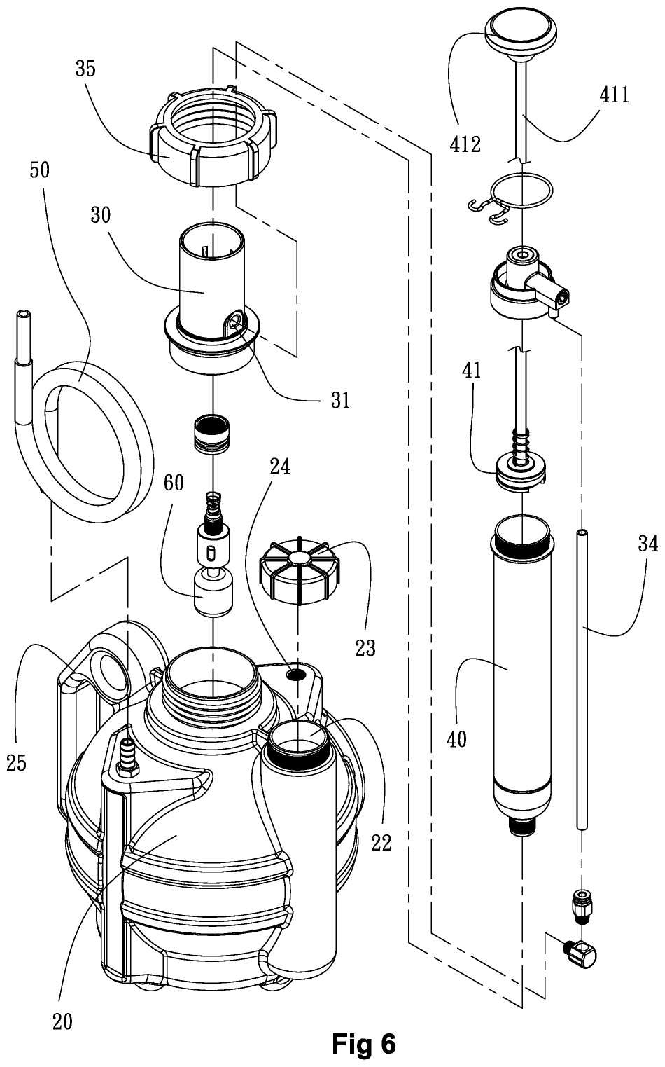

Referring to FIGS. 4-6, the present invention provides a hand-depressing vacuum pumping device, comprising the following components/parts:

A liquid container 20 comprises a receiving space 21 formed in an interior thereof

A guide cover 30 is mounted to a top end of the liquid container 20. The guide cover 30 is formed with a first passage 31 and a second passage 32. The first passage 31 is in communication with the receiving space in the interior of the liquid container 20. The first passage 31 is provided with and coupled to a check valve 33. The first passage 31 is arranged as a by-pass connected to an exposed tube 34.

A pump cylinder 40 has a top end to which the exposed tube 34 is connected to be in communication with an interior space of the pump cylinder 40. The pump cylinder 40 comprises a one-way piston 41 arranged in the interior space thereof to divide the interior space into an upper-side space 42 and a lower-side space 43. The one-way piston 41 is connected to a piston rod 411 and a pressing stem 412. The pump cylinder 40 has a bottom end connected to the guide cover 30. The lower-side space 43 of the pump cylinder 40 is connected, at the bottom end, to and in communication with one end of the second passage 32 of the guide cover 30. The second passage 32 has an opposite end that extends to and in communication with the outside or the surrounding environment. A liquid drawing tube 50 is arranged at one side of the liquid container 20 and connected to and in communication with the receiving space 21. Depressing the pressing stem 412 downward makes the one-way piston 41 to expel air contained in the lower-side space 43 to the outside and pulling the pressing stem 412 upward causes air contained in the interior of the liquid container 20 to flow through the upper-side space 42 and the one-way piston 41 to reach and enter the lower-side space 43, so that repeating such operations would evacuate air contained in the receiving space 21 to generate a negative pressure or vacuum therein that provides a vacuum-induced suction force for drawing liquid into the container. The components are simple in structure and the number of the components is small. In addition, these components are arranged as being exposed outside the container and being detachable so that removal and remounting of such components are easy and replacement can be carried out easily. Further, the operation of the device is carried out through depressing so that the operation can be carried out with less effort. The device, in the entirety thereof, only occupies a reduced amount of space, and the operation of the device, as described above, is easy and simple.

Referring to FIGS. 4-6, the hand-depressing vacuum pumping device of the present invention is structured such that the first passage 31 is connected to a float-based safety switch 60, wherein the float-based safety switch 60 is arranged at an upper portion of the receiving space 21 and at a relatively high location in the receiving space so that the float of the float-based safety switch 60 only floats up when the receiving space is almost filled up with liquid and this would close and seal the first passage 31 to serve as a safety mechanism that stops liquid from being further drawn into the container after the container is full.

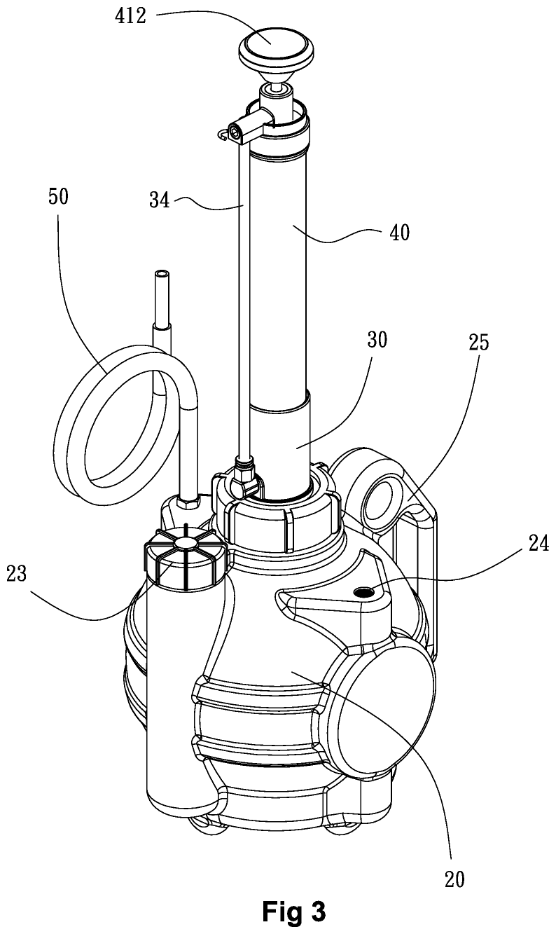

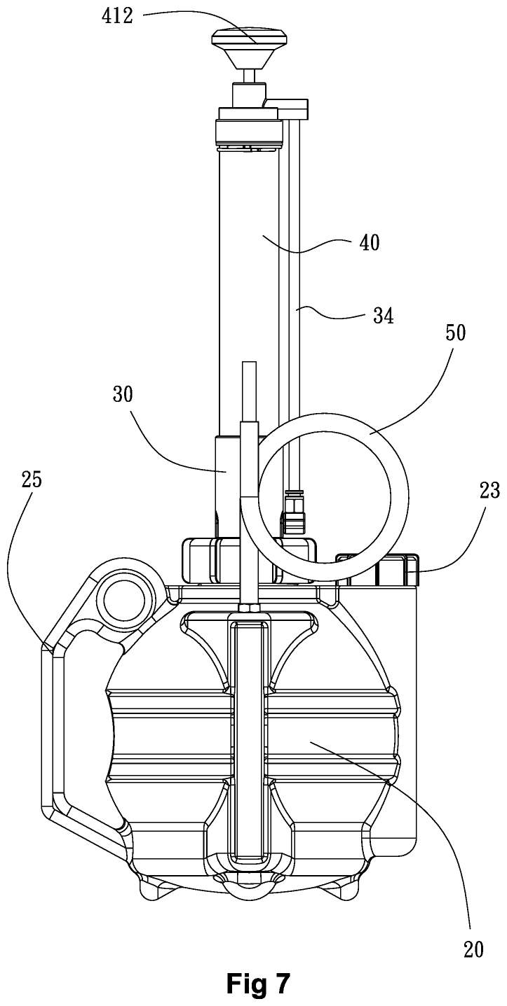

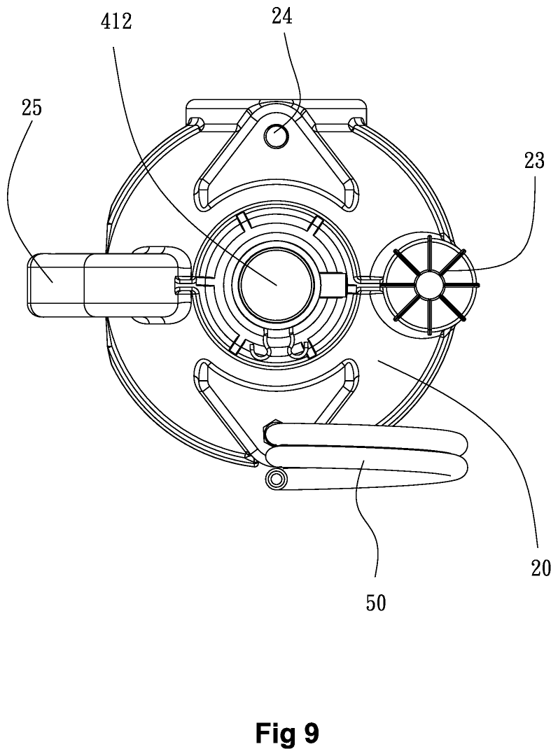

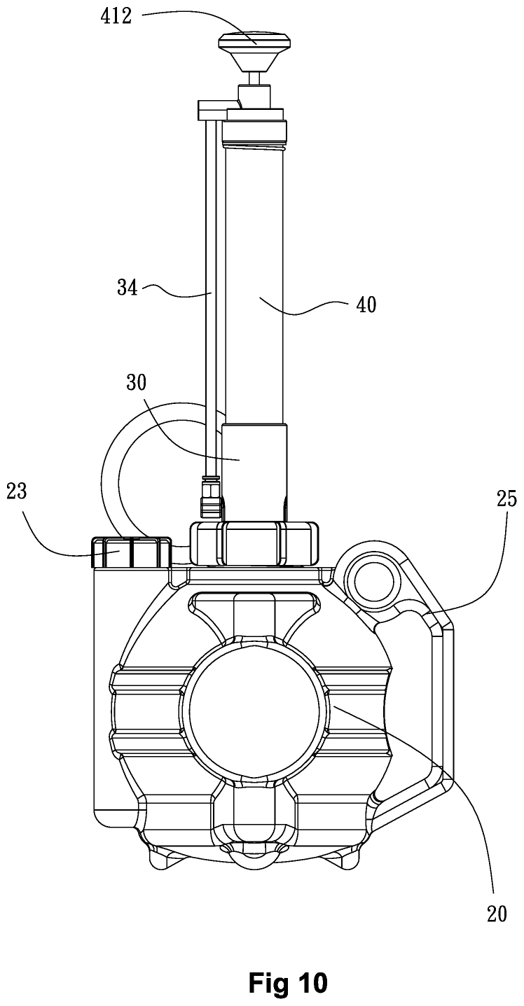

Referring to FIGS. 3, 4, 6, 7, 9, and 10, the hand-depressing vacuum pumping device of the present invention is structured such that the liquid container 20 is formed, at one side thereof, with a liquid pouring opening 22 that is connected to and in communication with the receiving space 21. The liquid pouring opening 22 may be provided with a rotary cap 23 for removably closing and sealing the opening.

Referring to FIGS. 3, 6, and 9, the hand-depressing vacuum pumping device of the present invention is structured such that the liquid container 20 is formed, at a different location, with a through hole 24 that is connected to and in communication with the receiving space 21. The through hole 24 is provided for receiving a pressure gauge to install thereon, or the through hole can be just closed with a plug fit therein.

Referring to FIGS. 3, 4, 6, 7, 9, and 10, the hand-depressing vacuum pumping device of the present invention is structured such that the liquid container 20 is provided with a handle 25 on a sidewall thereof. The handle 25 is provided for easy carrying of the device.

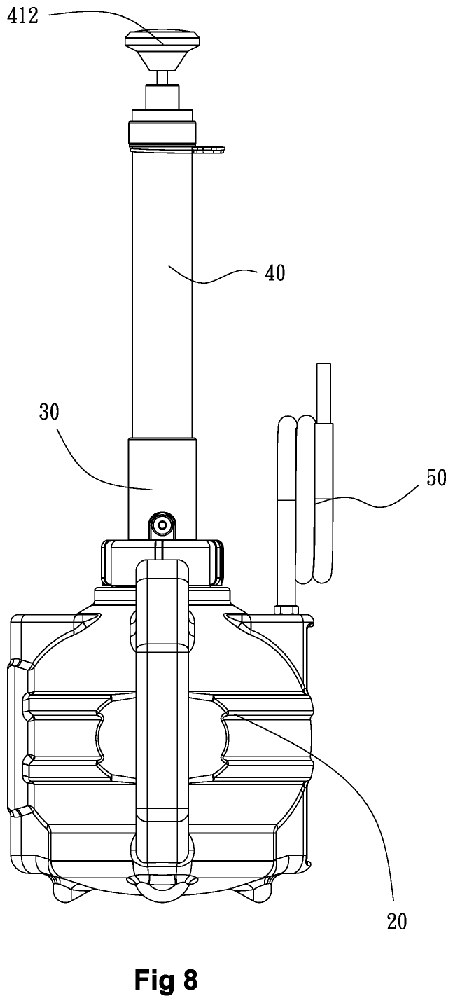

Referring to FIGS. 3 and 7-10, in this invention, the pump cylinder 40 is exposed to the outside and is detachable. The pump cylinder 40 is removably coupled to the guide cover 30, and the guide cover 30 is fastened by just a fastening cap 35 to the liquid container 20, so that loosening the fastening cap 35 through rotating or screwing would allow the guide cover 30 to detach from the liquid container 20 and the pump cylinder 40 can then be separated from the guide cover 30 through rotation and/or pulling. Further, the hand-depressing vacuum pumping device is operated through depressing. Depressing or pressing down is the best way for applying a force to the device. The known device as discussed previously requires repeated pulling and pushing in a sideway direction and would suffer potential issue of immobility when the pressure reaches a certain level, and this is also applicable for devices that are operated through upward pulling, as the same issue of immobility would occur after the pressure reaches a certain level. Such a problem, however, is less significant or not existing for the device of this invention that is operated through downward pressing or depressing. Thus, in view of the above description, the present invention is advantageous in that the components of the device are simple in structure and the number of the components is small; these components are arranged as being exposed outside and detachable so that removal and remounting of such components are easy and replacement can be carried out easily. Further, the operation of the device is carried out through depressing so that the operation can be carried out with less effort. The device does not occupy a large amount of space, and the operation of the device is easy and simple.

Illustrated above are the embodiments of the present disclosure, which should not be considered limitative to the scope of the invention. Therefore, any equivalent substitutions or variations to the structures or processes disclosed in the specification and the drawing of the present disclosure, or a direct or indirect application of the invention to the other technical fields should be considered as part of the present disclosure.

1. A hand-depressing vacuum pumping device, comprising:
a liquid container, which comprises a receiving space formed in an interior thereof;
a guide cover, which is mounted to a top end of the liquid container, the guide cover being formed with a first passage and a second passage, the first passage being in communication with the receiving space in the interior of the liquid container, the first passage comprising a check valve mounted thereto, the first passage being connected to and in communication with an exposed tube; and
a pump cylinder, which has a top end connected to the exposed tube for being in communication therewith, the pump cylinder having an interior space in which a one-way piston is movably received to divide the interior space into an upper-side space and a lower-side space, the one-way piston being connected to a piston rod and a pressing stem, the pump cylinder having a bottom end connected to the guide cover, the lower-side space being connected, at the bottom end of the pump cylinder, to and in communication with one end of the second passage of the guide cover, the second passage having an opposite end adapted to be in communication with the outside, a liquid drawing tube being arranged at one side of the liquid container and in communication with the receiving space, wherein depressing the pressing stem downward causes the one-way piston to expel air out of the lower-side space and puling the pressing stem upward causes air inside the liquid container to flow through the upper-side space and the one-way piston to the lower-side space, such that depressing and pulling are repeated to evacuate the receiving space to induce vacuum that in turn provides a suction force adapted to draw liquid into the container.
wherein the first and second passages and the check valve of the guide cover and the pump cylinder collectively form an air evacuation device that is removably mounted to the top end the liquid container by the guide cover and located outside the receiving space of the liquid container so as to allow the piston to move in a direction toward the liquid container to expel air out.

2. The hand-depressing vacuum pumping device as claimed in claim 1, wherein the first passage is connected a float-based safety switch.

3. The hand-depressing vacuum pumping device as claimed in claim 1, wherein the liquid container is formed with a liquid pouring opening in communication with the receiving space, a rotary cap being attached to the liquid pouring opening for closure and sealing.

4. The hand-depressing vacuum pumping device as claimed in claim 1, wherein the liquid container is formed with a through hole in communication with the receiving space and adapted to receive a pressure gauge to mount thereto.

5. The hand-depressing vacuum pumping device as claimed in claim 1, wherein the liquid container is provided with a handle attached to a sidewall thereof.
